(19) United States
(12) Patent Application Publication
(10) Pub. No.: US 2026/0202831 A1
(43) Pub. Date: Jul. 16, 2026

(54) AUTOMATED MISSION FACILITATION SYSTEMS AND METHODS USING DIGITAL REPLICAS OF INDUSTRIAL ASSETS

(71) Applicant: BP International Limited, Middlesex (GB)

(72) Inventors: Noyan Songur, Middlesex (GB); Chetan Kalsi, Middlesex (GB)

(73) Assignee: BP International Limited, Middlesex (GB)

(21) Appl. No.: 19/444,405

(22) Filed: Jan. 9, 2026

(30) Foreign Application Priority Data
Jan. 14, 2025 (GB) 2500458.1

(51) Int. Cl. G05B 19/418

(52) U.S. Cl. CPC G05B 19/41865; G05B 19/4185; G05B 2219/40174

(57) ABSTRACT

A computer-implemented method for facilitating one or more missions using a digital replica of an industrial asset includes receiving by a mission planning engine of a mission facilitation system one or more separate asset datasets from the digital replica, each of the one or more asset datasets pertaining to the industrial asset, receiving by the mission planning engine a task dataset defining a list of tasks to be performed on the industrial asset, generating by the mission planning engine and based on the one or more separate asset datasets, for each task contained in the task dataset, a mission plan including one or more logically ordered actions to be performed by one or more agents of the industrial asset to complete the task, and providing by the mission facilitation system the mission plan to one of the one or more agents of the industrial asset.

### CROSS-REFERENCE TO RELATED APPLICATIONS

This application is a non-provisional application claiming priority to United Kingdom (GB) Patent Application No. 2500458.1 filed Jan. 14, 2025, and entitled “Automated Mission Facilitation Systems and Methods Using Digital Replicas of Industrial Assets,” which is hereby incorporated herein by reference in its entirety for all purposes.

### STATEMENT REGARDING FEDERALLY SPONSORED RESEARCH OR DEVELOPMENT

Not applicable.

### BACKGROUND

Industrial assets, such as offshore platforms, well systems, chemical and refining plants, manufacturing plants, power stations, hydrogen production facilities, renewable energy facilities such as solar arrays and wind farms, and transportation hubs, rely on complex systems of machinery and infrastructure. Traditional methods for monitoring and managing these facilities often involve time-consuming and costly physical inspections and maintenance. Digital replica or “twin” technology, such as used in three-dimensional (3D) digital replicas or process replicas, aims to replicate these facilities in a virtual environment, allowing for real-time monitoring, predictive maintenance, and simulation.

### BRIEF SUMMARY OF THE DISCLOSURE

An embodiment of a computer-implemented method for facilitating one or more missions using a digital replica of an industrial asset comprises (a) receiving by a mission planning engine of a mission facilitation system one or more separate asset datasets from the digital replica, each of the one or more asset datasets pertaining to the industrial asset, (b) receiving by the mission planning engine a task dataset defining a list of tasks to be performed on the industrial asset, (c) generating by the mission planning engine and based on the one or more separate asset datasets, for each task contained in the task dataset, a mission plan comprising one or more logically ordered actions to be performed by one or more agents of the industrial asset to complete the task, and (d) providing by the mission facilitation system the mission plan to one of the one or more agents of the industrial asset. In some embodiments, the one or more asset datasets comprises at least one of equipment sensor data, robot sensor data, and asset representation data. In some embodiments, the method comprises (e) receiving by the mission planning engine one or more separate contextual datasets from the digital replica, wherein each of the one or more contextual datasets is at least one of pertains to the industrial asset and an environment in which the industrial asset is located. In certain embodiments, the one or more contextual datasets comprises an asset analytics dataset configured to forecast a future condition of the asset using the one or more separate asset datasets. In certain embodiments, the one or more contextual datasets comprises a climate dataset configured to forecast future local climatic conditions of the environment. In some embodiments, the method comprises (f) aggregating by the mission planning engine the one or more asset datasets with the one or more contextual datasets to provide an aggregated dataset, wherein (c) comprises generating by the mission planning engine and based on the aggregated dataset, for each task contained in the task dataset, the mission plan comprising the one or more logically ordered actions to be performed by the one or more agents of the industrial asset to complete the task. In some embodiments, the method comprises (e) receiving by the mission planning engine a teleoperation dataset indicative of the availability of one or more teleoperated robots of the industrial asset. In certain embodiments, (d) comprises (d1) providing by the mission facilitation system teleoperation instructions to the one or more teleoperated robots, wherein the one or more agents comprise the one or more teleoperated robots and the mission plan comprises the teleoperation instructions. In certain embodiments, (d) comprises (d1) assigning by the mission planning engine specific tasks of the one or more logically ordered actions to specific agents of the one or more agents. In some embodiments, the method comprises (e) assigning by a mission optimization engine of the mission facilitation system and based on the task dataset a priority to each of the one or more logically ordered actions, and (f) optimizing by the mission optimization engine the mission plan to provide an optimized mission plan comprising an optimized one or more logically ordered actions, wherein (d) comprises providing by the mission facilitation system the optimized mission plan to the one of the one or more agents of the industrial asset. In some embodiments, (d) comprises assigning by the mission planning engine specific tasks of the one or more logically ordered actions to specific agents of the one or more agents, and (e) comprises reassigning by the mission optimization engine at least some of the specific tasks of the one or more logically ordered actions to the specific agents of the one or more agents. In certain embodiments, (e) comprises assigning by the mission optimization engine the priority to each of the one or more logically ordered actions based on at least one of timeliness data and risk data contained in the task dataset.

An embodiment of a computer-readable medium storing executable code which, when executed by a processor, causes the processor to (a) receive by a mission planning engine of a mission facilitation system one or more separate asset datasets from a digital replica of an industrial asset, each of the one or more asset datasets pertaining to the industrial asset, (b) receive by the mission planning engine a task dataset from a mission management platform defining a list of tasks to be performed on the industrial asset, (c) generate by the mission planning engine and based on the one or more separate asset datasets, for each task contained in the task dataset, a mission plan comprising one or more logically ordered actions to be performed by one or more agents of the industrial asset to complete the task, and (d) provide by the mission facilitation system the mission plan to one of the one or more agents of the industrial asset. In certain embodiments, the executable code, when executed by the processor, causes the processor to (e) assign by a mission optimization engine of the mission facilitation system and based on the task dataset a priority to each of the one or more logically ordered actions, and (f) optimize by the mission optimization engine the mission plan to provide an optimized mission plan comprising an optimized one or more logically ordered actions, wherein (d) comprises providing by the mission facilitation system the optimized mission plan to the one of the one or more agents of the industrial asset.

An embodiment of a computer-implemented method for facilitating one or more missions using a digital replica of an industrial asset, the method (a) receiving by a mission planning engine of a mission facilitation system one or more separate asset datasets from the digital replica, each of the one or more asset datasets pertaining to the industrial asset, (b) receiving by the mission planning engine a task dataset defining a list of tasks to be performed on the industrial asset, (c) generating by the mission planning engine and based on the one or more separate asset datasets, for each task contained in the task dataset, a mission plan assigning a selected task to one or more agents of the industrial asset, (d) performing by a mission optimization engine of the mission facilitation system a risk assessment for each of the mission plans to generate one or more corresponding optimized mission plans whereby at least some of the one or more agents are reassigned from a first task to a different task of the list of tasks, and (e) providing by the mission facilitation system the one or more optimized mission plans to the one or more agents assigned to the one or more optimized mission plans. In some embodiments, the one or more asset datasets comprises at least one of equipment sensor data, robot sensor data, and asset representation data. In some embodiments, the method comprises (f) receiving by the mission planning engine one or more separate contextual datasets from the digital replica, wherein each of the one or more contextual datasets is at least one of pertains to the industrial asset and an environment in which the industrial asset is located. In certain embodiments, the one or more contextual datasets comprises an asset analytics dataset configured to forecast a future condition of the asset using the one or more separate asset datasets. In certain embodiments, the one or more contextual datasets comprises a climate dataset configured to forecast future local climatic conditions of the environment. In some embodiments, the method comprises (f) aggregating by the mission planning engine the one or more asset datasets with the one or more contextual datasets to provide an aggregated dataset, wherein (c) comprises generating by the mission planning engine and based on the aggregated dataset, for each task contained in the task dataset, the mission plan comprising one or more logically ordered actions to be performed by the one or more agents of the industrial asset to complete the task.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 depicts a computer system for displaying a screen image showing a portion of a digital replica of an industrial asset according to some embodiments;

FIG. 2 depicts a graphical user interface (GUI) showing a view of the industrial asset according to some embodiments;

FIG. 3 depicts a GUI showing another view of the industrial asset according to some embodiments;

FIG. 4 depicts a block diagram of an industrial asset according to some embodiments;

FIG. 5 depicts a flowchart of a computer-implemented method for facilitating one or more missions using a digital replica of an industrial asset according to some embodiments;

FIG. 6 depicts a block diagram of a computer system according to some embodiments; and

FIGS. 7 and 8 depict flowcharts of additional computer-implemented methods for facilitating one or more missions using a digital replica of an industrial asset according to some embodiments.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As described above, digital replica technology aims to replicate industrial assets in a virtual environment, allowing for real-time monitoring, predictive maintenance, and simulation. Using offshore production facilities as an example, some offshore production facilities are referred to as floating cities because even the smallest offshore platforms have more than a dozen people living and working aboard. Larger facilities, which may be anchored to the sea bed below, might have as many as 200 people aboard to operate the facility effectively. Maintaining production facilities that pump thousands of barrels of oil a day from a subterranean reservoir disposed below the sea floor utilizes—at all times—a variety of essential personnel performing different jobs including, without limitation, operators, maintenance technicians, welders, divers, engineers, cooks, safety personnel, and medical personnel. In addition to such personnel, additional maintenance personnel regularly travel to the facility for equipment inspections and maintenance. At least some of these regular maintenance activities are preventive in nature, and thus, are performed visually.

In addition to the regular maintenance activities, an equipment survey crew is typically sent aboard when the offshore production facility to inspect pipework for corrosion or when equipment is modified, for example, by replacing an important piece of equipment, such as a pump. These multiple layers of inspection and maintenance add to the overall cost, are time consuming, and create redundancies. In addition, offshore production facilities are inherently complex and can be dangerous; the constant influx and outflow of people may add to risks. Thus, it is generally desirable to reduce the number of people aboard an offshore production facility at any given time.

To improve the quality, performance, and efficiency of inspection and maintenance, the power of automation and data is used by the facility operators, engineers, maintenance and inspection crews to aid their decision making. In some cases, the offshore production facility may use the following types of maintenance-related software tools: integration and data management software, operations planning and reporting software, analytics and assurance software, real-time solutions software, equipment condition monitoring software, etc. The list of software tools mentioned herein is not exhaustive. Each of the above-mentioned software tools performs a multiplicity of different functions and generates a surfeit of distributed data relevant to its operators. The use of a large number of software tools is sometimes cost ineffective and generates distributed data, which may create redundancies and reduce the overall efficiency of the inspection or maintenance of the facilities. Thus, there is a need for systems and methods to mitigate the issues mentioned above. In particular, there is a need to aggregate all the distributed data to reduce redundancies and fully utilize the generated data. Such systems and methods may improve the quality of equipment maintenance, reduce the number of people aboard at any given time, and enhance the use of automation tools overall.

Digital replica technology aims to address at least some of these issues by replicating the features of a given industrial asset in a virtual environment. However, conventional digital replicas of industrial assets suffer from several limitations which limit their efficacy and applicability. For example, digital replicas themselves are not generally integrated into the process of facilitating the completion of tasks for maintaining and operating the industrial asset. Such tasks may include regular maintenance, responding to issues that arise (e.g., equipment failure and other issues) during the operation of the industrial asset, operational changes to the industrial asset, and alterations to the structural configuration of the industrial asset. Instead, the facilitation of such tasks typically falls on the shoulders of human personnel of the industrial asset who manually assign said tasks to agents of the industrial asset in a manner that may not necessarily be the safest or most resource efficient while at the same time burdening the personnel with said duties.

Accordingly, embodiments of automated mission facilitation systems and associated methods are described herein intended to automate the process of facilitating the completion of various tasks of the industrial asset and which leverage the data aggregated within a dynamic digital replica of the industrial asset. Particularly, embodiments of mission facilitation systems described herein may leverage a variety of different datasets including, for example, sensor data, equipment history data, contextual data (e.g., current and/or forecasted climatic data) to maximize the safety and resource efficiency in the completion of said tasks.

In an embodiment, a computer-implemented, automated mission facilitation system may receive by a mission planning engine thereof one or more separate asset datasets from the digital replica, each of the one or more asset datasets pertaining to the industrial asset. Additionally, the mission facilitation system may receive by the mission planning engine thereof a task dataset defining a list of tasks to be performed on the industrial asset. For each task contained in the dataset, and based on the one or more separate asset datasets, the mission planning engine may generate a mission plan. The mission plan may include (explicitly or implicitly) one or more logically ordered actions to be performed by one or more agents of the industrial asset to complete the task. Further, the mission facilitation system may provide the mission plan to one of the one or more agents of the industrial asset. In certain embodiments, the mission facilitation system also includes a mission optimization engine that may perform a risk assessment for each of the mission plans to generate one or more corresponding optimized mission plans whereby at least some of the one or more agents are reassigned from a first task to a different task of the list of tasks.

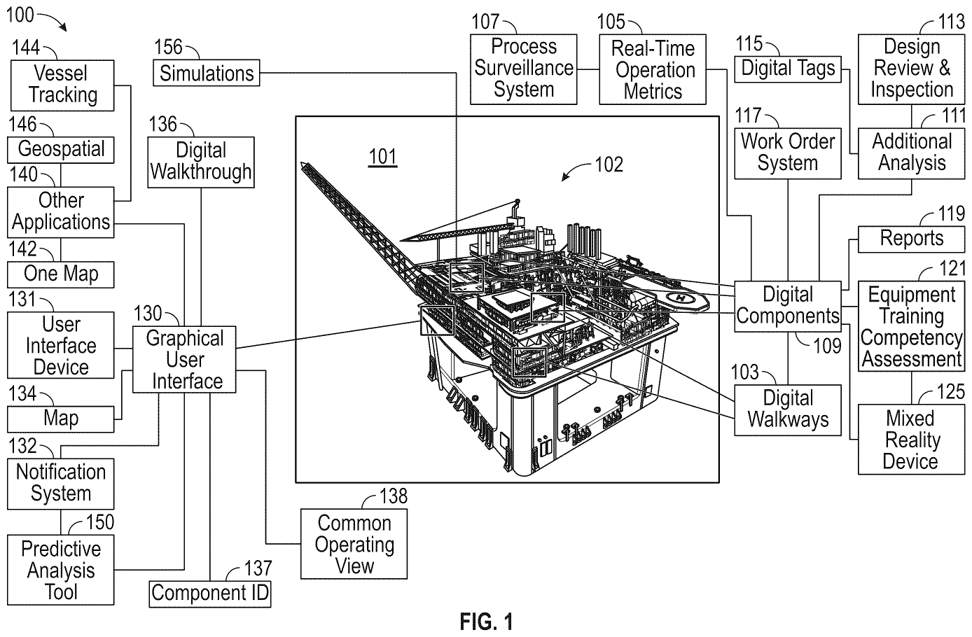

Initially, techniques for generating a basic digital replica of an industrial asset will be discussed, where embodiments of dynamic digital replicas may be generated from the underlying basic digital twin, as will be discussed further herein. Refer now to FIG. 1, a computer system 100 for displaying a screen image 101 illustrating a portion of a dynamic digital replica 102 of an industrial asset is shown. In this exemplary embodiment, the industrial asset comprises an offshore production facility; however, it may be understood that the type of industrial asset may vary depending on the given application. For example, in other embodiments, the industrial asset may comprise a subterranean wellbore drilling or completion facility, a refining, chemical, or other fluid processing facility, a construction facility, a hydrogen production facility, renewable energy facilities such as solar arrays and wind farms, and so on and so forth.

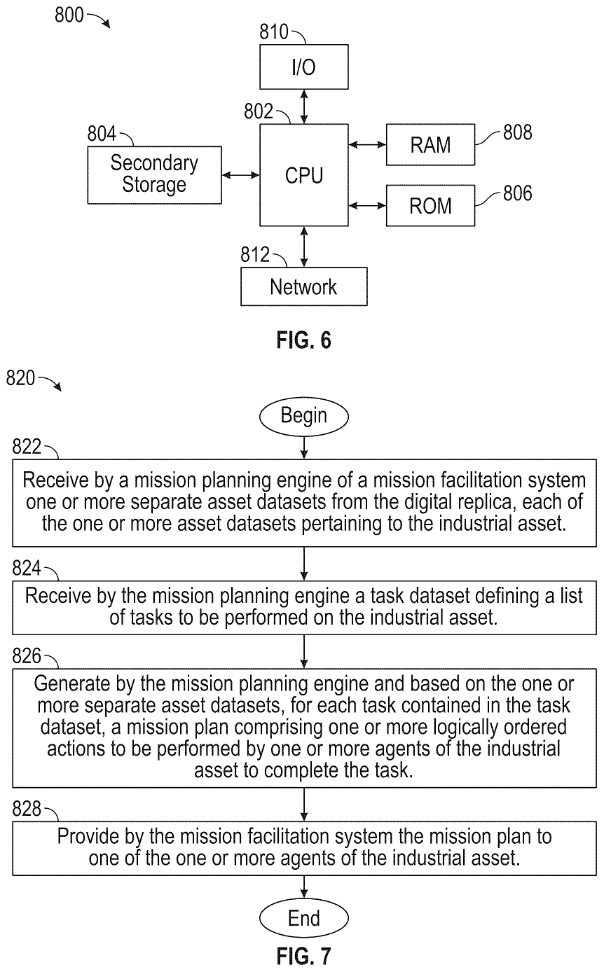

The computer system 100 may be the computer system discussed below with respect to FIG. 6, for example. The screen image 101 of FIG. 1 illustrates the portion of the offshore production facility positioned above the sea. The screen image 101 includes a platform of the offshore production facility built on concrete or steel legs anchored directly onto the seabed. The additional equipment that is present on the seabed, for example, trees, manifold, pipeline end termination system (PLET), riser, jumper, flowlines, etc., are not shown in FIG. 1. However, it should be appreciated that the description herein relates to digital replica of the complete offshore production facility (in this example, the offshore production facility being other types of industrial assets in other examples), not just the portion of the dynamic digital replica 102 shown in the screen image 101.

The dynamic digital replica 102 is a computer-generated visualization of the complete offshore production facility such that the dynamic digital replica 102 acts as an information databank in all four dimensions of time and space. In particular, the dynamic digital replica 102 transforms currently implemented software systems that generate distributed dataset into a four-dimensional (three-dimensional (3D) space plus time) repository that can be visually and temporally browsed and analyzed. The time domain may be provided by the sensors placed on the production facility. For example, the sensors may be positioned on all the equipment used in the offshore production facility, where the sensors track the health of the equipment and provide dynamic tracking reports. These tracking reports may be accessed by the operator and may also be used to visually indicate the health of the equipment.

FIG. 1 also depicts various illustrative attributes of the dynamic digital replica 102, some of which enable the dynamic digital replica 102 to function as an interactive rendering of the offshore production facility. It should be appreciated that the attributes shown in FIG. 1 are not an exhaustive list. The attributes are shown to illustrate some of the capabilities of the dynamic digital replica 102. Given the wide variation of equipment, conditions, and situations that may be encountered in the offshore production facility, all possible attributes that may be needed for all the possible scenarios cannot possibly be presented in this specification. As such, only some examples of such scenarios will be provided in this specification.

Illustrative attributes of the dynamic digital replica 102 will now be described. One of the key attributes of the dynamic digital replica 102 is a graphical user interface (GUI) 130 that is accessible through a two-dimensional (2D) pixel matrix of display unit, for example, monitors of computers or display screens of other electronic devices, such as mobile phones, handheld computers, or computer-interfaced image projection devices, or a combination thereof. The GUI 130 interactively displays a four-dimensional (4D) view of the offshore production facility onto the 2D pixel matrix of display screens. The GUI 130 may be a component located on the production facility, for example. The GUI 130 provides the operator with a set of widgets, such as buttons, sliders, choice and list boxes, which enable the operator to generate requests, which may include transferring from one type of viewpoint to another. The GUI 130 may be accessible utilizing a web browser that provides the operator with access to the most recent version of the GUI 130, independent of the combination of hardware and operating system utilized and independent of the location of the hardware and operating system. For example, the dynamic digital replica 102 may be viewed at a location remote from the actual location of the offshore production facility, such as a regional service office or an operations headquarters.

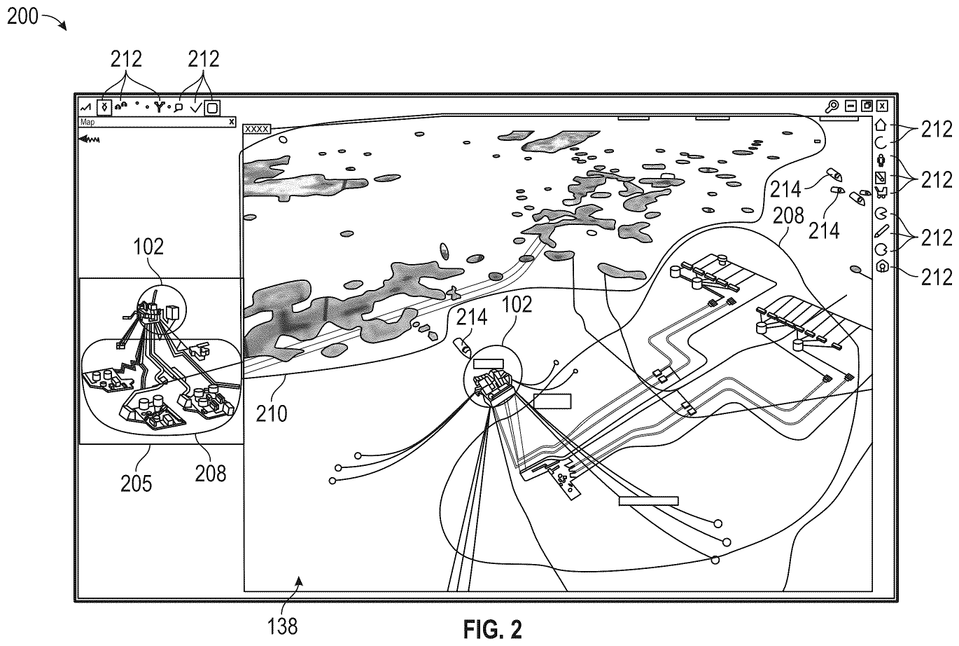

Referring briefly to FIG. 2, an illustrative GUI 200 is depicted. The GUI 200 may be the GUI 130 (FIG. 1), for example. The GUI 200 includes a basic digital replica of the complete offshore production facility, which includes the view of the dynamic digital replica 102 as shown in FIG. 1 and other components 208 that may form the offshore production facility. The GUI 200 also depicts a map 205 that shows the complete offshore production facility. The GUI 200 further depicts a set of widgets 212 that are present on the top and side of the GUI 200. In one example, the widgets 212 on the top of the GUI 200 may include a tree view option and a change view option, and the widgets 212 on the side of the GUI 200 may include a filter option, a dimension measurement option, an adding text option, a changing color option, etc.

Assume that the GUI 200, when turned on for the first time, displays a full-field digital replica view (as shown in FIG. 2) illustrating a common operating view 138 (FIG. 1), which includes a real-time weather view 210 and a view of locations of vessels 214 overlaid upon a view of all other components coupled to the offshore production facility and sharing similar map coordinates to the real-time weather view 210 and the view of the locations of vessels 214. The view of locations of vessels 214 may be generated utilizing an automatic identification system (AIS). The AIS shows real-time locations of the vessels using transponders on the ships via a vessel tracking 144 (FIG. 1). Now, the operator can select the appropriate widgets to access a desired basic digital replica, for example, the offshore production facility as shown in the view of the dynamic digital replica 102. After selecting the offshore production facility as represented by the view of the dynamic digital replica 102 in the GUI 200, the operator may see a view as shown in screen image 101 as shown in FIG. 1, for example.

Referring again to FIG. 1, as noted above, the dynamic digital replica 102 of the offshore production facility is interactive in that operators can manipulate the spatial location and orientation of the perspective viewpoint of the facility via a user interface device 131, such as a mouse, joystick, trackball, or touchscreen, to create an effect of actually walking through the computer-generated 4D visual scene. This walking through attribute is herein referred to as a digital walkthrough 136. During the digital walkthrough 136, the operator may perform a component ID 137 by selecting, highlighting, identifying, and accessing various digital equivalents of the equipment. This creates a first-person user experience of the facility even when being remote. To perform a digital walkthrough 136, for example, the operator may zoom in and select to view one of the digital walkways 103 on the facility. While on one of the digital walkways 103, the operator may digitally walk around the platform and, using the user interface device 131, select a piece of equipment in the instant visual scene. For example, the operator may select a digital equivalent of a piece of equipment, an iron roughneck present in the instant visual scene, of one of the digital walkways 103. In other examples, the operator may utilize the component ID 137 to view the component without first selecting one of the digital walkways 103.

As can be seen in FIG. 1, some of the attributes are depicted as being linked with other attributes. However, such links between attributes does not imply a relationship, such as dependence or causality. The links are merely shown to provide examples of the way in which one or more of the attributes can function together. There may be one or more of the attributes that may not be linked but that can function together. For example, an operator using the GUI 130 can perform the digital walkthrough 136 and can perform the component ID 137 during the digital walkthrough 136. In some examples, equipment can be identified by digital tags 115 that may mark each piece of equipment present in the digital walkthrough. In other examples, the operator may need to utilize the user interface device 131 to select the digital equivalent of the equipment to see the digital tags 115.

In addition to identifying components, the dynamic digital replica 102 is configured to provide more details on the identified component. For the sake of illustration, assume that the operator identifies a digital component 109 as a pump while digitally walking through one of the digital walkways 103 of the dynamic digital replica 102. The operator can access real-time operation metrics 105 of the identified digital component 109. For example, the operator can gather live equipment and process data such as vibration data, shaft speed, flow rate, pressure, and temperature, etc. of the pump. In addition to real-time operation metrics 105, the operator can also access reports 119 of the identified digital component 109. For example, the operator may access specification reports, schematics, reliability reports, maintenance history, integrity database, data sheet, pump curve, and equipment health assessment, etc. of the pump. After accessing these reports, the operator may review and inspect the design of the identified digital component 109 utilizing a design review and inspection 113.

In addition to being able to check real-time operation metrics 105, the dynamic digital replica 102 is configured to perform additional analysis 111 on the instant visual scene or any selected component or piece of equipment. For example, assume that the GUI 130 displays the offshore production platform shown in the screen image 101. The operator, using the appropriate widgets on the GUI, can view a corrosion circuit model of the complete offshore production platform. Corrosion circuit modeling is carried out as part of a risk-based analysis (RBA). Corrosion circuit modeling combines fluid type and piping materials or chemical make-up into systems or sub-systems, which can be grouped into corrosion or erosion mechanisms. These mechanisms are monitored over the operating lifetime of the facility in accordance with an operating management system (OMS) that defines a systematic and consistent approach for managing operating activities. The OMS may be implemented as an OMS application of other applications 140 available through the GUI 130. By utilizing the OMS, the dynamic digital replica 102 allows visualization and connection of disparate data to improve performance, reinforcing a commitment to operate safe and reliable operations compliant with the OMS. This monitoring is further utilized in the integrity management plan (IMP) which, in some examples, may form a part of the overall asset integrity management system. In addition to viewing the corrosion circuit of the offshore production platform, the operator may isolate a particular corrosion circuit and access risk-based analysis reports of the isolated corrosion circuit. Furthermore, the operator may also access piping and instrumentation diagram of the isolated corrosion circuit.

The additional analysis is not limited to corrosion circuits. In other examples, additional analysis 111 may also include comparing theoretical design calculations and actual operating conditions—for example comparing actual erosion data with erosion modeling data, actual turbine thermodynamic data with turbine thermodynamic modeling, etc. These comparisons are monitored over the operating lifetime of the facility in accordance with the OMS. In some examples, the basic digital replica may allow viewing of a predicted aging of a piece of equipment, of a system, or of the production facility as a whole. The predicted aging may be based on one of the plurality of models available. For example, the dynamic digital replica 102 may provide a view of corrosion within the production facility six months from a current date utilizing theoretical calculations, actual operating conditions, past data, or a model based on a combination thereof to predict and display the aging of the piece of equipment, the system, or of the production facility as a whole. This capability allows an operator to schedule maintenance as well as predict possible operations interruptions for further analysis.

The GUI 130 may allow access to a map 134 that provides the operator another spatial viewpoint on the operator's instant spatial location on or in the dynamic digital replica 102. For example, using the user interface device 131, the operator may digitally walk to a location in the dynamic digital replica 102 where a pump is placed. At this point, the operator may see on the display screen her current location within the dynamic digital replica 102. The current location in the map 134, in some examples, may be labeled or marked as a colored dot.

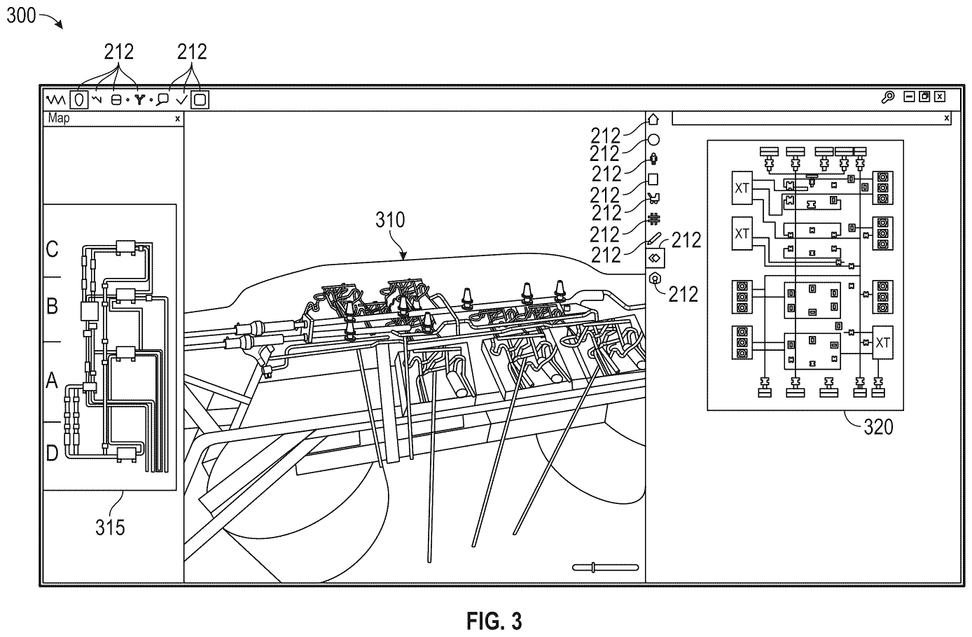

The dynamic digital replica 102 also includes a process surveillance system 107 that provides live process data for selected pieces of equipment or systems of the offshore production facility and collected by one or more sensors such as a network of internet of things (IoT) sensors. Refer briefly to FIG. 3, an illustrative GUI 300 showing a view of equipment 310 placed on the seabed. The GUI 300 may be the GUI 130 (FIG. 1), for example. The equipment 310 may be a sub-system or system shown by selecting one or more than one of the components 208 of the common operating view 138 of the GUI 200, for example. The GUI 300 shows the widgets 212, an overall field view 315, a detail schematic diagram 320, and live process data of the equipment 310. The equipment 310 includes motors and pipes pumping oil in real-time from the reservoir underneath the seabed. The live process data includes flow direction, flow rate, pressure, and temperature. The live process data also allows for the operator to manipulate a sub-system or sub-component of the equipment 310 and analyze the effect it may have on the overall system. For example, the operator, using the user interface device, may turn-off a valve and check its effect on the equipment 310. This capability is especially useful in examples where a portion of equipment needs to be replaced and the operator wants to check the effect the downtime will have on the other systems. In another example, the operator may utilize the turned-off valve as an input into the OMS application to determine the effect the downtime will have on the other systems.

While troubleshooting a problem or scenario, the operator may utilize different attributes of the dynamic digital replica 102. For example, the operator may access a work order history of the valve from a work order system 117 to review all the preventative and corrective maintenance performed on the valve in the past year. In addition, the operator may also access the real-time operation metrics 105 of the equipment in which the valve is present. The operator can also view the pneumatic schematic in the reports 119. If, after troubleshooting, it is concluded that the valve needs to be replaced, the operator can access a spare parts inventory and confirm whether a warehouse has a replacement part.

In summary, the dynamic digital replica 102 facilitates inspection and/or maintenance activities by aggregating all relevant data in one visual repository (dynamic digital replica 102), where an operator can access the relevant data more efficiently and without creating redundancies.

In one example, dynamic digital replica 102 utilizes a digital tag algorithm that facilitates accessing relevant details based on the digital tags 115. The digital tags 115 may be used to identify pieces of the equipment and their associated activities or documents. The digital tag algorithm searches and cross-references all systems and data to generate relevant output based on the digital tags 115 of the identified equipment. This allows users to navigate around the plethora of information visually using the dynamic digital replica 102. Additionally, using the digital tag algorithm reveals discrepancies between data sources and allows rectification of the discrepancy at its source, which in turn improves quality and accuracy. By implementing the digital tag algorithm in compliance with the OMS, a systematic and consistent approach for managing data is provided.

In some examples, the GUI 130 may also provide access to other applications 140. The other applications 140 are machine-readable instructions that cause a processor to perform the actions specified or to cause the actions to be performed by another component of a computer system. The computer system may be the computer system 100, for example. The other applications 140 include Geospatial Information System (GIS) 142, and vessel tracking 144, for example. GIS 142 is configured to provide region-wide visibility of vessels, facility, subsea structure, and reservoir development data. Integrating GIS 142 with the dynamic digital replica 102 assists with the vessel tracking 144. GIS 142 provides details related to the offshore production facility, including coordinates of the equipment, vessels, production facility, etc., and assists with defining a coordinate-based view of the common operating view 138, for example.

In some examples, the dynamic digital replica 102 is configured to provide equipment training competency assessments to essential personnel. The dynamic digital replica 102, in some examples, may be configured to perform simulations 156. The simulations 156 may be material handling simulations, for instance. In one example, the simulations 156 may be accessed by selecting a digital walkway. In another example, the simulations 156 may be accessed by selecting a digital component or a digital system. In yet another example, the simulations 156 may be accessed utilizing the GUI 130. In some examples, the GUI 130 may be assumed by a mixed-reality device 125. The mixed-reality device 125 may also be a component of the production facility, for example. The GUI 130 may display on a display screen of the mixed-reality device 125. The functions an operator may perform using the GUI 130 applies to the mixed-reality device 125, but instead of using the user interface device 131, the operator may use a user interface device related to the mixed-reality headset. The user interface device related to the mixed-reality device 125 may be sensors for detecting hand movements, for example.

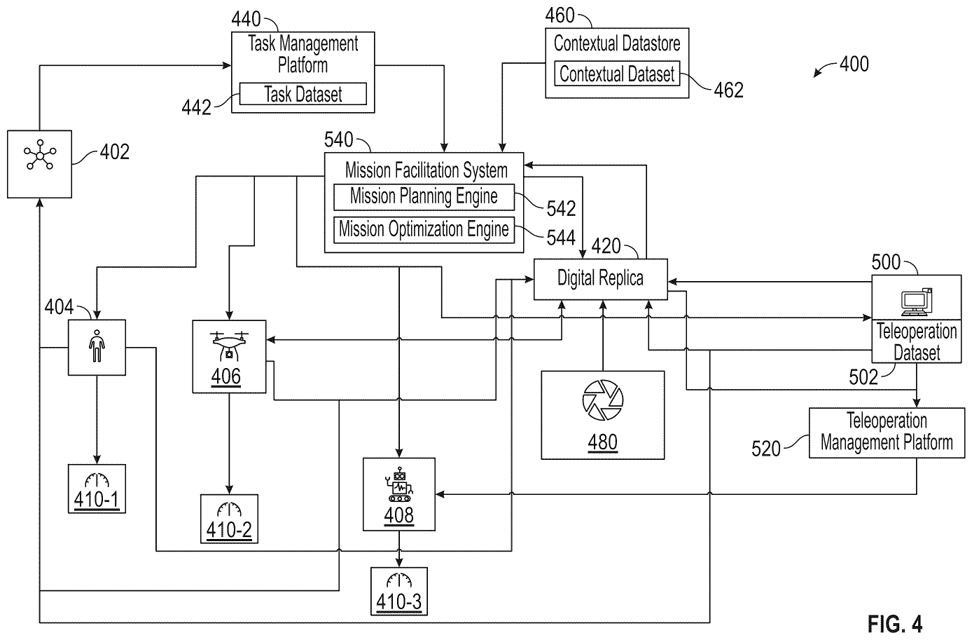

Referring to FIG. 4, an embodiment of an industrial asset 400 is shown. In this exemplary embodiment, industrial asset 400 generally includes an asset control room or center 402, a dynamic digital replica 420, a task management platform 440, a contextual datastore 460, a distributed sensor network 480, a teleoperator center 500, a teleoperation management platform 520, and a mission facilitation system 540. Additionally, industrial asset 400 includes one or more agents for performing various tasks on or around the industrial asset 400. As used herein, the term “agent” is defined as encompassing both human agents or personnel as well as non-human agents or robots including both remotely or teleoperated robots (e.g., teleoperated by a human teleoperator) and autonomous robots that may not be teleoperated by a human teleoperator. Additionally, the robots discussed herein include both aerial robots or drones and ground-based robots such as automated guided vehicles (AGV), autonomous ground-based robots such as AGVs, quadrupeds, crawlers, and the like. For instance, in this exemplary embodiment, industrial asset 400 includes agents in the form of one or more human agents 404 (e.g., personnel of industrial asset 400), one or more autonomous robots 406, and one or more teleoperated robots 408. In some embodiments, at least some of the autonomous robots 406 may also be teleoperated by a human teleoperator. Further, industrial asset 400 includes a plurality of asset equipment 410 (shown as asset equipment 410-1, 410-2, and 410-3 in FIG. 4) which the agents of industrial asset 400 (e.g., agents 404, 406, and/or 408) may interact or engage.

Although, for the sake of discussion, industrial asset 400 is described as including asset control center 402, dynamic digital replica 420, task management platform 440, contextual datastore 460, distributed sensor network 480, teleoperator center 500, teleoperation management platform 520, and mission facilitation system 540, one or more of these features of industrial asset 400 may be physically located at least partially offsite from a physical facility or site of the industrial asset 400. As an example, the dynamic digital replica 420 may be stored in a datastore (e.g., of a computer system such as a server) that is located offsite from the physical location of the industrial asset 400. Additionally, in some embodiments, one or more of these features may be separate from and not comprise a feature of industrial asset 400. For instance, in some embodiments, the contextual datastore 460 may be received by the industrial asset 400 from a third party. Similarly, the teleoperator center 500 and/or teleoperation management platform 520 may be provided as services by a third party and thus may form a dedicated feature of industrial asset 400.

Asset equipment 410 of industrial asset 400 may comprise various types of equipment including electromechanical equipment (e.g., an internal combustion engine, an electric motor, a hydraulic actuator), fluidic equipment (e.g., one or more valves or valve assemblies, pressure vessels), and the like. Distributed sensor network 480 of industrial asset 400 comprises a plurality of sensors in signal communication with the dynamic digital replica 420 of industrial asset 400. At least some of the sensors of distributed sensor network 480 monitor one or more operational or equipment parameters (e.g., pressure, temperature, speed, flow rate, vibration, strain) of asset equipment 410 which may be provided in real-time or near real-time to the dynamic digital replica 420. For instance, the distributed sensor network 480 may provide real-time monitoring of pressure, temperature, and other parameters of a pressure vessel of industrial asset 400 of the dynamic digital replica 420 whereby users of the dynamic digital replica 420 may remotely monitor these parameters in real-time.

The asset control center 402 of industrial asset 400 may be located onsite (physically at the industrial asset 400) and/or offsite. Personnel of industrial asset 400 may manage the operation of industrial asset 400 and its various equipment (e.g., autonomous robots 406, asset equipment 410) via the asset control center 402. For example, asset control center 402 may include one or more computer-implemented user interfaces for monitoring information pertaining to the industrial asset 400. For instance, the status of various agents of industrial asset 400 (e.g., agents 404, 406, and/or 408) and/or of asset equipment 410 may be monitored via the asset control center 402. Additionally, information may be provided directly to the asset control center 402 such as status updates (e.g., regarding the completion of missions as will be discussed further herein) provided by the different agents of industrial asset 400. Further, information may be inputted to the industrial asset 400 by personnel thereof via asset control center 402. For instance, different tasks to be completed (e.g., regular maintenance tasks pertaining to asset equipment 410) as part of operating industrial asset 400 may be entered into the task management platform 440 by personnel of industrial asset 400 via asset control center 402.

Dynamic digital replica 420 provides a continually updated computer-generated visualization (e.g., via laser scanning, integrated image sensor data) or twin of the industrial asset 400 that integrates a variety of information relevant to the industrial asset 400 including, for example, continually updated (e.g., in real-time or near real-time) sensor measurements provided by the distributed sensor network 480. As another example, dynamic digital replica 420 may provide continually updated (e.g., in real-time or near real-time) sensor measurements provided by autonomous robots 406 and/or teleoperated robots 408. As a further example, dynamic digital replica 420 may receive continually updated teleoperation data from the teleoperator center 500 of industrial asset 400. For instance, teleoperator center 500 may update dynamic digital replica 420 regarding the completion of various tasks or missions by the teleoperated robots 408 of industrial asset 400. Additionally, teleoperator center 500 may query the dynamic digital replica 420 regarding path planning for transporting a given teleoperated robot 408 through the industrial asset 400 to a desired piece of asset equipment 410 and the like.

As used herein, the term “mission” is defined as an assignment (e.g., an optimized assignment) that can be given to one or more agents (e.g., one or more human agents or persons and/or one or more non-human agents) to undertake a task or procedure comprising one or more separate tasks in order to monitor the status and/or maintain an optimized allocation or performance of assets and processes of an industrial asset under different conditions and risk factors. For instance, an exemplary mission could include a goal (e.g., thermally inspecting specific gauges of a selected piece of equipment of the industrial asset (defined by georeferenced coordinates from a digital replica thereof) having a predefined completion deadline, one or more attendant risk factors (e.g., strong winds at the location of the selected gauges, equipment operating at elevated temperature in the vicinity of the selected gauges), a list of sensors required to complete the mission (e.g., a thermal camera), and supporting IoT sensor information (e.g., normal status on relevant sensors).

In this manner, dynamic digital replica 420 defines a 4D data repository (including, among other things, continually updated sensor data, specification reports, schematics, reliability reports, maintenance history, integrity databases, data sheets, operational envelopes, and equipment health assessments) that can be visually and temporally browsed and analyzed by users of dynamic digital replica 420 that are located remotely from the industrial asset 400. For instance, in some embodiments, dynamic digital replica 420 is configured similarly or at least includes some features in common with the dynamic digital replica 102 shown in FIG. 1. The dynamic digital replica 420 may be accessible via a GUI having features in common with GUIs 130, 200, and 300 shown in FIGS. 1-3, respectively. However, dynamic digital replica 420 may vary in its configuration and/or functionalities relative to dynamic digital replica 102 in at least some embodiments. For instance, in some embodiments, instead of dynamic digital replica 420 the industrial asset 400 may comprise a data aggregation model other than a dynamic digital replica.

Dynamic digital replica 420 may facilitate a digital walkthrough (e.g., similar to digital walkthrough 136 shown in FIG. 1) of the industrial asset 400 to permit a user to perform a component ID similar to the component ID 137 shown in FIG. 1 whereby equipment of industrial asset 400 may be identified by corresponding digital tags (e.g., similar to digital tags 115 shown in FIG. 1). Dynamic digital replica 420 may permit a user to access real-time operation metrics (e.g., similar to real-time operation metrics 105) and reports pertaining to selected equipment including specification reports, schematics, reliability reports, maintenance history, integrity database, data sheet, pump curve, and equipment health assessment, etc. of selected equipment. In some embodiments, dynamic digital replica 420 is also configured to perform additional analysis including, for example, the additional analysis 111 shown in FIG. 1 and may utilize an OMS.

The task management platform 440 receives one or more tasks pertaining to the industrial asset 400 from one or more different sources including, for example, the asset control center 402 of industrial asset 400. As described above, these tasks may comprise maintenance tasks (e.g., to accomplish regularly scheduled inspections or to perform maintenance or in response to an equipment failure or other issue), operational tasks (e.g., adjusting the position of a valve, operating a lever, switch, or other control of a piece of asset equipment 410 to alter its operation), and others. Some tasks may define a procedure including a plurality of logically (e.g., temporally) ordered subtasks each of which must be completed in order to complete the overall task. In this manner, task management platform 440 may act as a data repository containing a task dataset 442 defining a list of tasks to be performed on the industrial asset 400. Additionally, in this exemplary embodiment, the tasks contained in task dataset 442 are not assigned to one or more selected agents of the industrial asset 400. Instead, as will be discussed further herein, mission facilitation system 540 is configured to assign the given tasks of task dataset 442 to one or more agents for completion.

The task dataset 442 may be continually updated in response to the addition and/or completion of one or more tasks of the industrial asset 400 or according to a predefined cadence (e.g., updated hourly, daily, weekly, monthly). New tasks may be added by to the task dataset 442 and/or removed from the task dataset 442 in response to the requirements of the industrial asset 400 and in response to the completion of assigned tasks by one or more agents of the industrial asset 400. As will be described further herein, tasks from the task dataset 442 may be assigned for execution whereby the assigned tasks are provided by the task management platform 440 to the mission facilitation system 540.

The contextual datastore 460 of industrial asset 400 provides additional data relevant to managing the industrial asset 400 but that may not be contained in the dynamic digital replica 420. Contextual Datastore 460 includes or contains one or more associated contextual datasets 462. At least some of this additional or external data may contextualize data provided by the dynamic digital replica 420, and thus may be referred to generally herein as contextual data. Examples of such contextual data included in contextual datastore 460 include, among other things, analytics such as predictive models (e.g., predictive maintenance models), prognostic and health management models, live weather data, weather forecasting models, equipment (e.g., spare parts) delivery schedules, and the like. As a further example, the contextual data may include localized weather simulations for forecasting the impact of different weather patterns on the industrial asset 400 such as variations in wind speed through the industrial asset 400, presence of wet surfaces during prolonged exposures to rain, and the like. In some embodiments, at least some of the information contained in the contextual dataset 462 may be obtained via sources external the industrial asset 400.

The teleoperator center 500 of industrial asset 400 acts as a control or command center for the various teleoperated robots 408 of industrial asset 400 and may be located onsite and/or offsite of the industrial asset 400 (e.g., the physical facility or installation of the industrial asset 400 containing asset equipment 410). For instance, teleoperator center 500 may include one or more teleoperator interfaces through which one or more corresponding human teleoperators may provide commands (e.g., via a joystick, lever, switch, keyboard, mouse, tactile sensing gloves, body motion trackers, immersive headsets, and/or other input device of the teleoperator center 500) for teleoperating the teleoperated robots 408 while receiving sensor data (e.g., via a visual screen or monitor, head mounted displays (HMDs), virtual reality (VR) headsets, and the like of the teleoperator center 500) from the teleoperated robots 408. Additionally, teleoperator center 500 may receive information (e.g., in response to queries made by the human teleoperators) from the dynamic digital replica 420 and/or other features of industrial asset 400 such as, for example, the mission facilitation system 540. For instance, human teleoperators may query the dynamic digital replica 420 to determine a path along which a teleoperated robot 408 controlled by the human teleoperator may take through the industrial asset 400 to accomplish one or more tasks (e.g., obtained from task dataset 442).

Additionally, in this exemplary embodiment, the teleoperator center 500 provides or includes a teleoperator dataset 502 that includes information pertaining to the various teleoperated robots 408 of industrial asset 400. For instance, teleoperator dataset 502 may indicate the availability of selected teleoperated robots 408 and/or of the human teleoperators of the industrial asset 400. For instance, teleoperator dataset 502 may include scheduling information for the human teleoperators indicating the current and future availability of the human teleoperators for controlling the teleoperated robots 408 for completing one or more tasks (e.g., tasks obtained from task dataset 442). Similarly, teleoperator dataset 502 may include scheduling information for the teleoperated robots 408 themselves indicating the current and future availability of the teleoperated robots 408 for completing one or more tasks.

The teleoperation management platform 520 of industrial asset 400 provides commands inputted by human teleoperators at teleoperator center 500 to their teleoperated robots 408 to assist in completing different tasks provided by the task dataset 442 of task management platform 440. For instance, teleoperation management platform 520 may contain software or algorithms which translate the commands provided by the human teleoperators at teleoperator center 500 into machine-readable instructions that may be understood and acted upon by the teleoperated robots 408 of industrial asset 400.

The mission facilitation system 540 of industrial asset 400 receives tasks of industrial asset 400 for completion from the task dataset 442 of task management platform 440 along with asset datasets (or simply “asset data”) from the dynamic digital replica 420 and associated with one or more pieces of selected asset equipment 410. Particularly, using the tasks and asset data received from the task management platform 440 and dynamic digital replica 420, respectively, a mission planning engine 542 of the mission facilitation system 540 generates for each received task, a unique mission plan comprising one or more logically ordered actions to be performed by one or more agents (e.g., human agents 404, autonomous robots 406, and teleoperated robots 408) of the industrial asset 400 to complete the given task. In some embodiments, mission planning engine 542 comprises an artificial intelligence (AI) model such as a large language model (LLM) configured (e.g., fine-tuned) for sequential and operational (e.g., process-driven) data such as, for example, emergency response plans and/or basic day care activities. The AI model defining mission planning engine 542 may accept textual and/or visual data from the dynamic digital replica 420 and non-human agents of the industrial asset 400.

In this manner, mission facilitation system 540 may automatically assign each task received from task management platform 440 to one or more selected agents of industrial asset 400 (e.g., via providing the generated mission plan to the one or more agents) which may then carry out the assigned task to completion such that the completed task may be removed from the task dataset 442 of task management platform 440. The mission plan associated with a selected task may include one or more logically ordered actions that must be performed in order to complete the selected task. For instance, the one or more actions may be sequentially ordered, temporally ordered, spatially ordered, and the like. Additionally, the one or more actions of a selected mission plan may each be assigned to a designated agent of industrial asset 400. In this manner, a single agent of industrial asset 400 may be assigned with performing each action of the mission plan or the actions of the mission plan may be divided between multiple separate agents (e.g., between a human agent 404, an autonomous robot 406, and/or a teleoperated robot 408) of industrial asset 400.

Additionally, in this exemplary embodiment, mission facilitation system 540 includes a mission optimization engine 544 that optimizes the mission plan generated by the mission planning engine 542 to provide an optimized mission plan. In some embodiments, mission optimization engine 544 comprises another AI model that may incorporate one or more sub-models that are reinforcement-learning based or LLM-based. The AI model defining mission optimization engine 544 may make a risk assessment for each mission plan received thereby in order to generate one or more corresponding optimized mission plans for completing the various tasks received by the mission facilitation system 540.

The optimized mission plan may include one or more optimized, logically ordered actions to be performed in order to complete the given task associated with the optimized mission plan. The optimized actions of the optimized mission plan may vary from the actions contained in the original mission plan from which the optimized mission plan is generated. For instance, the ordering of optimized actions may vary from the order of the actions, and/or the optimized actions may include additional actions not included in the original mission plan and/or exclude actions included in the original mission plan. Additionally, the optimized actions may be reassigned to different agents with respect to their original assignments. Further, although mission facilitation system 540 is shown as including both the mission planning engine 542 and mission optimization engine 544 in FIG. 4; alternatively, mission facilitation system 540 may include only the mission planning engine 542 (and not the mission optimization engine 544) in other embodiments.

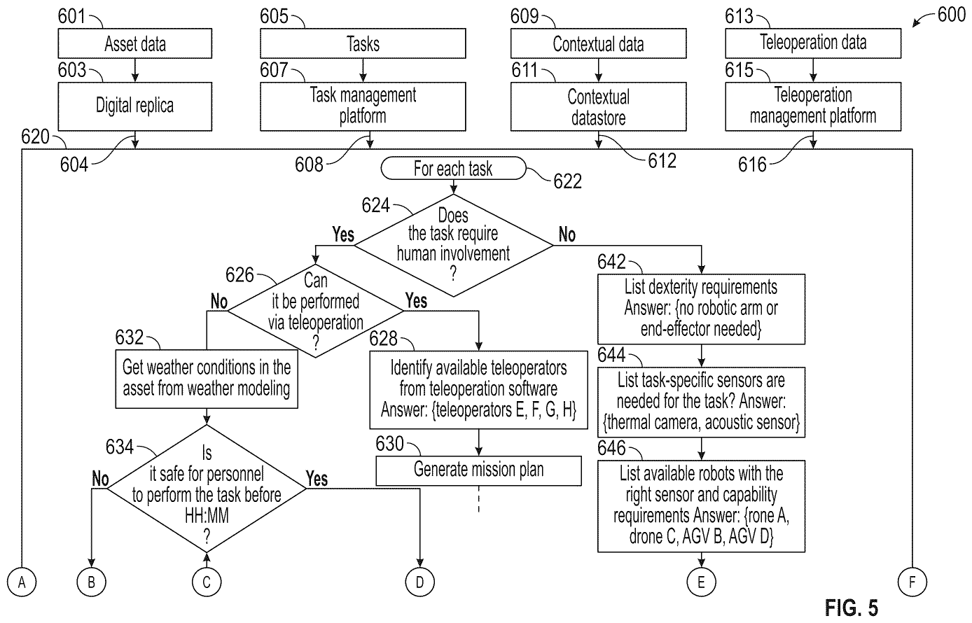

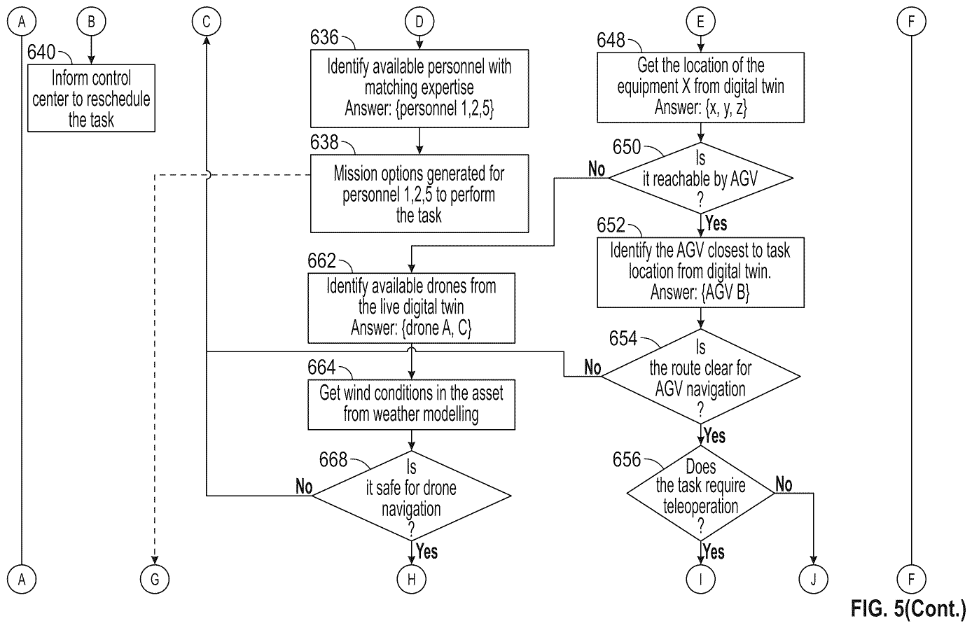

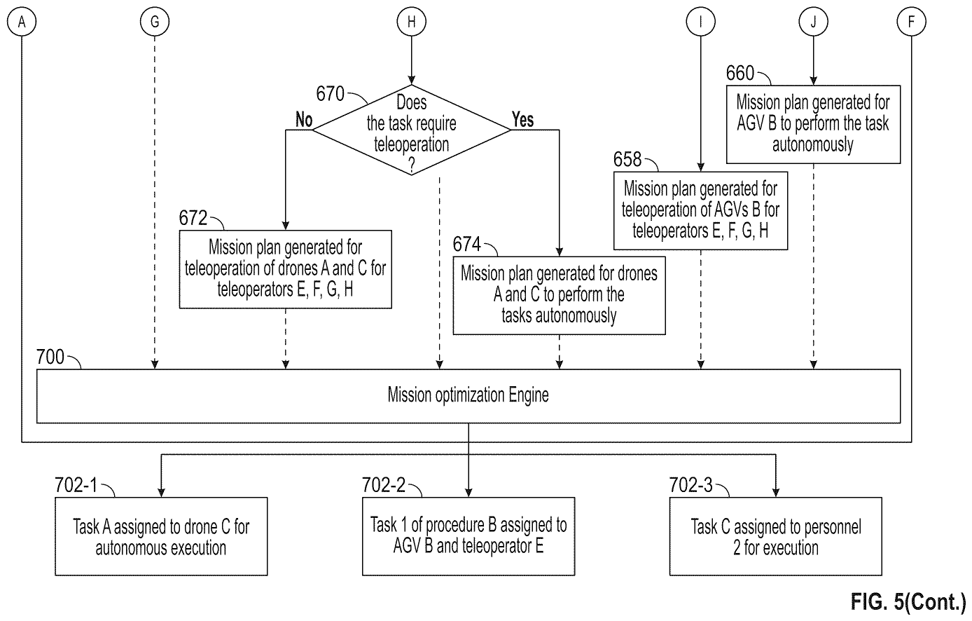

Referring to FIG. 5, an embodiment of a computer-implemented method 600 for facilitating one or more missions using a dynamic digital replica 603 of an industrial asset is shown. Method 600 may provide an example for implementing at least some of the features of the industrial asset 400 shown in FIG. 4, such as the mission facilitation system 540 thereof. For instance, a mission facilitation system 620 shown in FIG. 5 may have features in common with the mission facilitation system 540 of FIG. 4. However, method 600 may be implemented by systems that vary from the industrial asset 400 shown in FIG. 4. In some embodiments, mission facilitation system 620 may include or leverage one or more AI models such as one or more LLMs which may be trained or fine-tuned using data associated with the industrial asset corresponding to mission facilitation system 620.

Method 600 includes providing the mission facilitation system 620 with a variety of different types of data obtained from a corresponding variety of data sources. Particularly, in this exemplary embodiment, method 600 includes receiving (indicated by arrow 604 in FIG. 5) asset data 601 from the dynamic digital replica 603, and receiving (indicated by arrow 608 in FIG. 5) one or more tasks 605 (e.g., operating, replacing, and/or refurbishing a piece of asset equipment, performing a multi-step procedure using asset equipment, and the like) of the industrial asset from a task management platform 607. Additionally, in this exemplary embodiment, mission facilitation system 620 receives (indicated by arrow 612 in FIG. 5) contextual data 609 from a contextual datastore 611, and teleoperation data 613 from a teleoperation management platform 615 (indicated by arrow 616 in FIG. 5). Alternatively, the data received by mission facilitation system 620 may vary in other embodiments. For instance, in other embodiments, mission facilitation system 620 may receive additional types of data from corresponding additional data sources not shown in FIG. 5.

As indicated at block 622 of method 600, a predefined algorithm or workflow is automatically implemented for each task 605 received by the mission facilitation system 620. Initially, at decision block 624 of method 600, mission facilitation system 620 determines whether the involvement of a human agent (e.g., human agent 404 shown in FIG. 4) is required in completing the selected task 605. In some embodiments, mission facilitation system 620 determines one or more physical requirements for completing a selected task 605 and may compare or crosscheck these requirements with a corresponding set of physical capabilities of the available robots of the industrial asset (e.g., robots 406 and 408 shown in FIG. 4) to determine if the physical capabilities of any of the available robots. As an example, a selected task 605 of opening a valve may require the application of a predefined quantity of force which may be cross checked with the force capabilities of the available robots. In another example, the selected task 605 may require the agent to access an elevated height for inspecting selected equipment, which may be crosschecked with the physical capabilities (e.g., the ability to achieve the required height) of the available robots.

For tasks 605 in which the answer to decision block 624 is “YES,” method 600 proceeds to another decision block 626 where the mission facilitation system 620 determines automatically if the selected task 605 may be performed via teleoperation (e.g., via one or more of the teleoperated robots 408 shown in FIG. 4). In some embodiments, teleoperated robots may have a dexterity and delicateness (in physically interacting with its environment) that exceeds that of automated robots and which may be required by a selected task 605. Additionally, a selected task 605 may have a determined risk or risk profile that may exceed a predefined threshold of autonomous robots where such risky tasks must instead be performed by teleoperated robots in order to minimize said risk.

For tasks 605 in which the answer to decision block 626 is “YES,” method 600 proceed to block 628 where the mission facilitation system 620 identifies available human teleoperators for completing the selected task 605. For instance, the mission facilitation system 620 may identify available human teleoperators using the teleoperation data 613 provided thereto which may include status and/or scheduling information of human teleoperators having the ability to operate teleoperable robots (e.g., teleoperable robots 408 shown in FIG. 4) of the given industrial asset. Once suitable, available human teleoperators have been identified, a mission plan is generated automatically by the mission facilitation system 620 at block 630 which is provided to a mission optimization engine 700 of the mission facilitation system 620, as will be discussed further herein. Particularly, the mission plan generated at block 630 assigns automatically the selected task 605 to one or more of the available human teleoperators identified at block 628.

The mission plan generated at block 630 also includes one or more logically ordered actions to be performed by the assigned human teleoperators in order to complete the selected task 605. For instance, for the task 605 of replacing a component of a piece of asset equipment, the one or more logically ordered actions may include acquiring by the a robot operated by the assigned human teleoperator a replacement component, transporting the replacement component using the teleoperated robot to the piece of asset equipment, removing by the teleoperated robot the component to be replaced from the piece of asset equipment, and installing by the teleoperated robot the replacement component in the piece of asset equipment. These logically ordered actions may be expressed explicitly or implicitly in the mission plan generated at block 630. For instance, the mission plan may contain only the action of the replacing the component in the above example with the human teleoperator themselves understanding that the task of replacing the component inherently includes the logically ordered actions outlined above.

For tasks 605 in which the answer to decision block 626 is “NO,” method 600 proceeds at block 632 where climatic data (pertaining to ambient conditions at the physical location of the industrial asset) is obtained by the mission facilitation system 620 such as climatic data contained in the contextual data 609 received thereby. Once climatic data is obtained at block 632, the mission facilitation system 620 determines automatically at decision block 634 if it is safe, in view of the collected climatic data, for human agents to complete the selected task 605 by a predefined task deadline of the selected task 605. For instance, if the climatic data indicates the presence of elevated wind, rain, lightning, and/or other dangerous conditions, mission facilitation system 620 may decide it is unsafe for human agents to complete the selected task 605 by the task deadline. In some embodiments, the task deadline is included in the selected task 605 and is thus received by the mission facilitation system 620 from the task management platform 607, for instance. Alternatively, the mission facilitation system 620 itself may automatically generate a task deadline for a given task 605 received thereby.

If mission facilitation system 620 determines at decision block 634 that it is safe for human agents to complete the selected task 605 by its task deadline, then method 600 proceeds to block 636 where the mission facilitation system 620 identifies one or more appropriate human agents who are available to complete the selected task 605 by the task deadline. For instance, in identifying human personnel at block 636, mission facilitation system 620 may check their availability and the qualifications (e.g., technical skills, knowledge, expertise, licenses, job titles) of available human agents to identify available human agents having the required qualifications for completing the selected task 605. In some embodiments, the qualifications of human personnel may be stored in a datastore accessible by the mission facilitation system 620.

Having identified one or more human agents that are both available and qualified to complete the selected task 605, method 600 proceed at block 638 where the mission facilitation system 620 generates a mission plan for completing the selected task 605 by the task deadline and which assigns the selected task 605 to one or more of the human agents identified at block 636. Similar to the mission plan generated at block 630, the mission plan generated at block 636 includes one or more logically ordered actions (which may be represented explicitly or implicitly in the mission plan) to be performed by the assigned agents in order to complete the selected task 605.

If mission facilitation system 620 determines at decision block 634 that it is not safe for human agents to complete the selected task 605 by its task deadline, then method 600 proceeds to block 640 where the mission facilitation system 620 generates a request to change the task deadline or otherwise to reschedule the selected task 605 to a different time where the unsafe conditions determined at decision block 634 may no longer be present. For example, the rescheduling request may be provided by the mission facilitation system 620 to a control center (e.g., control center 402 shown in FIG. 4) of the industrial asset and/or to the task management platform 607. In some embodiments, the selected task 605 may be manually rescheduled by human agents of the industrial asset or automatically rescheduled by a component of the industrial asset such as the mission facilitation system 620 itself.

Additionally, for tasks 605 in which the answer to decision block 624 is “NO,” method 600 proceeds to block 642 where one or more dexterity requirements specific to the selected task 605 are determined. For instance, the dexterity requirements determined at block 642 may include the requirement of a robotic arm, the requirement for a particular end-effector such as a gripper or hand-like end-effector and the like, and/or other devices. In some embodiments, the dexterity requirement may be based on a required pressure sensing precision of the end-effector, torque and/or force application precision of the end-effector of the selected task 605 and the like.

Having determined one or more dexterity requirements at block 642, method 600 continues at block 644 where the mission facilitation system identifies automatically the types of sensors (e.g., thermal cameras, optical sensors, acoustic sensors, temperature sensors, flow sensors, pressure sensors) required to complete the selected task 605. In some embodiments, block 644 includes utilizing an AI model such as a LLM that has been fine-tuned on data associated with the given industrial asset.

Once the sensors required for completing the task are identified at block 644, method 600 continues at block 646 where one or more non-human agents (e.g., autonomous and/or teleoperated robots) having availability to complete the selected task 605 by its corresponding task deadline and which meet the dexterity requirements identified at block 642 and the sensor requirements identified at block 644 are identified. Although each of the non-human agents identified at block 646 have the functionalities required to complete the selected task 605 once positioned in proximity to the one or more pieces of asset equipment associated with the selected task 605, instances may arise where the piece of asset equipment is positioned at a location that is not reachable by one or more of the identified non-human agents.

In view of the above, method 600 proceeds from block 646 to block 648 where the mission facilitation system 620 obtains a physical task location (e.g., in 2D or 3D space such as global positioning system (GPS) coordinates and the like) where the selected task 605 is to be performed. For instance, the task location of a selected task 605 may correspond to the location of the one or more pieces of asset equipment associated with the selected task 605 (e.g., the physical location of a component or piece of asset equipment of the industrial asset to be replaced and the like). In some embodiments, mission facilitation system 620 obtains the task location of the selected task 605 from the dynamic digital replica 603 in which the desired location or positional information is contained. Having identified the task location, method 600 proceeds to a decision block 650 where the mission facilitation system 620 determines automatically if the identified task location is reachable by a ground-based non-human agent (e.g., based on a required elevation for completing the selected task 605) of the industrial asset such as an AGV and the like.

If mission facilitation system 620 decides at decision block 650 that the task location is reachable by ground-based non-human agents, then method 600 proceeds to block 652 where the ground-based non-human agent (e.g., an RGV and the like) located physically nearest the task location of the selected task 605 is identified. In other embodiments, the mission facilitation system 620 at block 652 may identify a plurality of the physically nearest ground-based non-human agents for selected tasks 605 requiring more than one agent for completion. Having identified the nearest available, ground-based, non-human agents of the industrial asset at block 652, method 600 proceeds to a decision block 656 where the mission facilitation system 620 determines automatically whether a clear or navigable route (e.g., unobstructed so as to be navigable by the ground-based non-human agents) between the agents identified at block 652 and the task location exists or at least may be identified.

If the mission facilitation system 620 determines at block 654 that the no navigable route exists (or is unable to identify such) between the agents identified at block 652 and the task location, method 600 proceeds to the decision block 634 described above. Conversely, if the mission facilitation system 620 is able to identify a navigable route at block 654, then method 600 instead proceeds to a decision block 656 where the mission facilitation system determines automatically if the selected task 605 requires teleoperation (e.g., cannot be performed by an autonomous non-human agent such as the autonomous robot 406 shown in FIG. 4). If the mission facilitation system 620 determines at decision block 656 that the selected task 605 requires teleoperation, then method 600 proceeds to block 658 where the mission facilitation system 620 generates automatically a mission plan for completing the selected task 605 via the teleoperation of the ground based, non-human agents identified at block 652. The selected task 605 may be assigned to one or more ground-based non-human agents along with one or more corresponding human teleoperators for controlling the operation of the ground-based non-human agents to complete the selected task 605. The human teleoperators may thus carry out one or more logically ordered actions through teleoperating the ground-based non-human agents to complete the selected task 605.

If the mission facilitation system 620 determines at decision block 656 that the selected task 605 does not require teleoperation, then method 600 proceeds to block 660 where the mission facilitation system 620 generates automatically a mission plan for completing the selected task 605 autonomously using the ground based, non-human agents identified at block 652. In some embodiments, the performance of block 660 is facilitated by a LLM or other AI model trained and/or fine-tined on data of the industrial asset. In this scenario, the selected task 605 may be assigned to only one or more ground-based non-human agents and not to any corresponding human teleoperators such that the ground-based non-human agents assigned to the selected task 605 may complete it autonomously.

Returning to decision block 650, in this exemplary embodiment, for selected tasks 605 in which the mission facilitation system 620 determines that the task location is instead not reachable by ground-based non-human agents, then method 600 proceeds to block 662 where the aerial non-human agent (e.g., an aerial drone and the like) located physically nearest the task location of the selected task 605 is identified. In other embodiments, the mission facilitation system 620 at block 652 may identify a plurality of the physically nearest aerial non-human agents for selected tasks 605 requiring more than one agent for completion. Having identified the nearest available, aerial, non-human agents of the industrial asset at block 662, method 600 proceeds to block 664 where the mission facilitation system 620 determines automatically wind conditions (e.g., wind speed, direction, and other information) for the industrial asset including the target location. In some embodiments, the mission facilitation system 620 may determine the (e.g., current) wind conditions from contextual data 609.

Having determined the relevant wind conditions, method 600 proceeds in this exemplary embodiment to block 668 where the mission facilitation system 620 determines if it is safe for the aerial non-human agents identified at block 662 to complete the selected task 605 (e.g., by a task deadline of the selected task 605) in view of the determined wind conditions. For instance, the mission facilitation system 620 may determine at block 668 that it is unsafe for the identified aerial non-human agents to complete the selected task 605 given that the determined wind speed exceeds predefined operational limits of the non-human agents. In response to determining at block 668 that it is unsafe for the aerial non-human agents to complete the selected task 605, method 600 proceeds to decision block 634 as described above.

Conversely, if the mission facilitation system 620 determines at block 668 that the selected task 605 may be safely completed (e.g., by a predefined task deadline) by the aerial non-human agents identified at block 662, then method 600 proceeds to decision block 670 where, similar to decision block 656 described above, where the mission facilitation system determines automatically if the selected task 605 requires teleoperation. Method 600 proceeds to block 672 should the mission facilitation system 620 determine at decision block 670 that completing the selected task 605 requires teleoperation. At block 672, mission facilitation system 620 generates automatically a mission plan for completing the selected task 605 that is assigned to both the aerial non-human agents identified at block 662 and one or more corresponding human teleoperators. Conversely, should mission facilitation system 620 determine at decision block 670 that teleoperation is not required, then method 600 proceeds to block 674 where the mission facilitation system 620 generates automatically a mission plan for completing the selected task 605 that is assigned to only the aerial non-human agents identified at block 662 which may complete the task autonomously rather than relying on human teleoperators for guidance or control.

As described above, based on the parameters of the selected task 605 and contextual information (e.g., current climatic conditions and the like), a variety of different mission plans may be generated by the mission facilitation system 620 such as those mission plans generated at blocks 630, 638, 658, 660, 672, and 674 of method 600. The generation of said mission plans may be performed by a mission planning engine of the mission facilitation system 620 that may, in some embodiments, include features in common or be configured similarly as the mission planning engine 542 shown in FIG. 4. Alternatively, the mission planning engine of mission facilitation system 620 responsible for generating the different mission plans at blocks 630, 638, 658, 660, 672, and 674 of method 600 may vary in configuration from the mission planning engine 542 shown in FIG. 4.

In this exemplary embodiment, the different mission plans generated at blocks at blocks 630, 638, 658, 660, 672, and 674 of method 600 are provided to the mission optimization engine 700 of mission facilitation system 620 which may adjust or optimize the mission plans received thereby to generate automatically one or more optimized mission plans represented by blocks 702 (shown as 702-1 through 702-3 in FIG. 5) of method 600. Particularly, the mission optimization engine 700 may reassign one or more agents of the industrial asset from a first task 605 to another, different task 605 based on a risk assessment performed by the mission optimization engine 700 on each of the mission plans received thereby and in view of one or more different datasets. For instance, the risk assessment made by the mission optimization engine 700 may be based on asset data 601 (e.g., sensor data pertaining to relevant asset equipment, the configuration (e.g., mobility, dexterity, sensor capabilities) of assigned non-human agents, the physical position of assigned non-human agents), tasks 605, contextual data 609 (e.g., current and forecasted climatic conditions, historical asset equipment data), and/or teleoperation data 613. Further, the risk assessment made by the mission optimization engine 700 for each received mission plan may also be based on information generated by the mission planning engine of mission facilitation system 620 such as, for example, the determine of whether the selected task 605 requires teleoperation or may be completed autonomously by one or more non-human agents of the industrial asset. In some embodiments, the risk assessment may leverage weather simulations such as wind simulations, impact of weather on surface conditions at the industrial asset, and current condition-based data such as operational parameters of the equipment, whether the equipment is corroded or otherwise at risk of failure.

Referring now to FIG. 6, an embodiment of a computer system 800 is shown suitable for implementing one or more components disclosed herein. As an example, computer system 800 may be used to execute various embodiments of mission facilitation systems (e.g., mission facilitation systems 540 and 620 shown in FIGS. 4 and 5, respectively) disclosed herein.

The computer system 800 of FIG. 6 generally includes a processor 802 (that is in communication with memory devices including secondary storage 804, read only memory (ROM) 806, random access memory (RAM) 808, input/output (I/O) devices 810, and network connectivity devices 812. The processor 802 may be implemented as one or more central processing unit (CPU) chips and/or one or more graphics processing unit (GPU) chips. It is understood that by programming and/or loading executable instructions onto the computer system 800, at least one of the processor 802, the RAM 808, and the ROM 806 are changed, transforming the computer system 800 in part into a particular machine or apparatus having the novel functionality taught by the present disclosure.

Additionally, after the system 800 is turned on or booted, the processor 802 may execute a computer program or application. For example, the processor 802 may execute software or firmware stored in the ROM 806 or stored in the RAM 808. In some cases, on boot and/or when the application is initiated, the processor 802 may copy the application or portions of the application from the secondary storage 804 to the RAM 808 or to memory space within the processor 802 itself, and the processor 802 may then execute instructions that the application is comprised of. In some cases, the processor 802 may copy the application or portions of the application from memory accessed via the network connectivity devices 812 or via the I/O devices 810 to the RAM 808 or to memory space within the processor 802, and the processor 802 may then execute instructions that the application is comprised of. During execution, an application may load instructions into the processor 802, for example load some of the instructions of the application into a cache of the processor 802. In some contexts, an application that is executed may be said to configure the processor 802 to do something, e.g., to configure the processor 802 to perform the function or functions promoted by the subject application. When the processor 802 is configured in this way by the application, the processor 802 becomes a specific purpose computer or a specific purpose machine.

Secondary storage 804 may be used to store programs which are loaded into RAM 808 when such programs are selected for execution. The ROM 806 is used to store instructions and perhaps data which are read during program execution. ROM 806 is a non-volatile memory device which typically has a small memory capacity relative to the larger memory capacity of secondary storage 804. The secondary storage 804, the RAM 808, and/or the ROM 806 may be referred to in some contexts as computer readable storage media and/or non-transitory computer readable media. I/O devices 810 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 812 may take the form of modems, modem banks, Ethernet cards, universal serial bus (USB) interface cards, wireless local area network (WLAN) cards, radio transceiver cards, and/or other well-known network devices. The network connectivity devices 812 may provide wired communication links and/or wireless communication links. These network connectivity devices 812 may enable the processor 802 to communicate with the Internet or one or more intranets. With such a network connection, it is contemplated that the processor 802 might receive information from the network, or might output information to the network. Such information, which may include data or instructions to be executed using processor 802 for example, may be received from and outputted to the network, for example, in the form of a computer data baseband signal or signal embodied in a carrier wave.

The processor 802 executes instructions, codes, computer programs, scripts which it accesses from hard disk, floppy disk, optical disk, flash drive, ROM 806, RAM 808, or the network connectivity devices 812. While only one processor 802 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 804, for example, hard drives, floppy disks, optical disks, and/or other device, the ROM 806, and/or the RAM 808 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

Referring now to FIG. 7, a flowchart of a computer-implemented method 820 for facilitating one or more missions using a digital replica (e.g., digital replicas 420 and 603 shown in FIGS. 4 and 5, respectively) of an industrial asset (e.g., industrial asset 400 shown in FIG. 4). Initially, at block 822 method 820 includes receiving by a mission planning engine (e.g., mission planning engine 542 shown in FIG. 4) of a mission facilitation system (e.g., mission facilitation systems 540 and 620 shown in FIGS. 4 and 5, respectively) one or more separate asset datasets (e.g., asset data 601 shown in FIG. 5) from the digital replica, each of the one or more asset datasets pertaining to the industrial asset.

At block 824, method 820 includes receiving by the mission planning engine a task dataset (e.g., task dataset 442 shown in FIG. 4) defining a list of tasks (e.g., tasks 605 shown in FIG. 5) to be performed on the industrial asset. At block 826, method 820 includes generating by the mission planning engine and based on the one or more separate asset datasets, for each task contained in the task dataset, a mission plan (e.g., mission plans generated at blocks 630, 638, 658, 660, 672, and 674 shown in FIG. 5) comprising one or more logically ordered actions to be performed by one or more agents (e.g., agents 404, 406, and 408 shown in FIG. 4) of the industrial asset to complete the task. At block 828, method 820 includes providing by the mission facilitation system the mission plan to one of the one or more agents of the industrial asset.

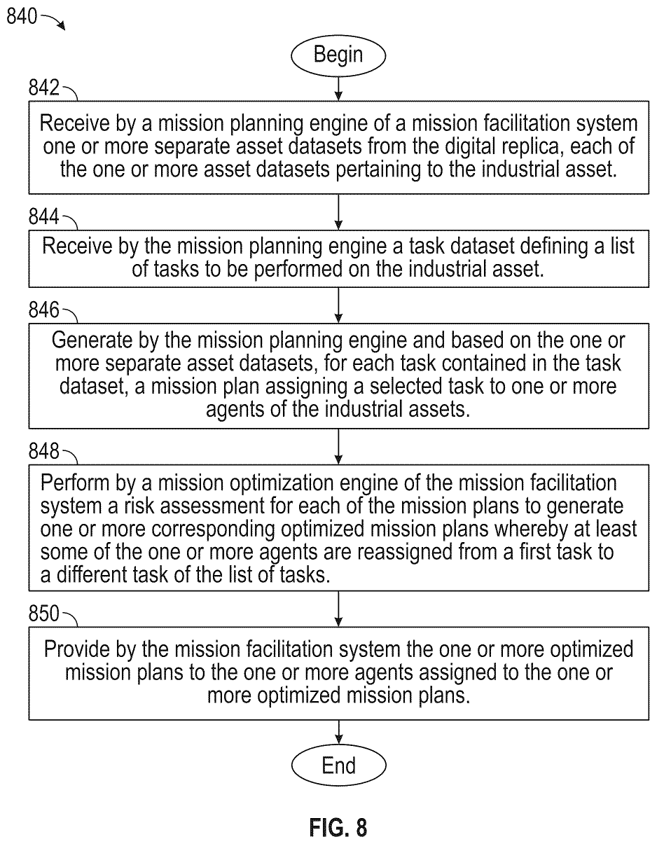

Referring now to FIG. 8, a flowchart of another computer-implemented method 840 for facilitating one or more missions using a digital replica (e.g., digital replicas 420 and 603 shown in FIGS. 4 and 5, respectively) of an industrial asset (e.g., industrial asset 400 shown in FIG. 4). Initially, at block 842 method 840 includes receiving by a mission planning engine (e.g., mission planning engine 542 shown in FIG. 4) of a mission facilitation system (e.g., mission facilitation systems 540 and 620 shown in FIGS. 4 and 5, respectively) one or more separate asset datasets (e.g., asset data 601 shown in FIG. 5) from the digital replica, each of the one or more asset datasets pertaining to the industrial asset.

At block 844, method 840 includes receiving by the mission planning engine a task dataset (e.g., task dataset 442 shown in FIG. 4) defining a list of tasks (e.g., tasks 605 shown in FIG. 5) to be performed on the industrial asset. At block 846, method 840 includes generating by the mission planning engine and based on the one or more separate asset datasets, for each task contained in the task dataset, a mission plan (e.g., mission plans generated at blocks 630, 638, 658, 660, 672, and 674 shown in FIG. 5) assigning a selected task to one or more agents (e.g., agents 404, 406, and 408 shown in FIG. 4) of the industrial asset. At block 848, method 840 includes performing by a mission optimization engine (e.g., mission optimization engines 544 and 700 shown in FIGS. 4 and 5, respectively) of the mission facilitation system a risk assessment for each of the mission plans to generate one or more corresponding optimized mission plans (e.g., the optimized mission plans generated at blocks 702 shown in FIG. 5) whereby at least some of the one or more agents are reassigned from a first task to a different task of the list of tasks. At block 850, method 840 includes providing by the mission facilitation system the one or more optimized mission plans to the one or more agents assigned to the one or more optimized mission plans.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for facilitating one or more missions using a digital replica of an industrial asset, the method comprising:
(a) receiving, by a mission planning engine, of a mission facilitation system one or more separate asset datasets from the digital replica, each of the one or more asset datasets pertaining to the industrial asset;
(b) receiving, by the mission planning engine, a task dataset defining a list of tasks to be performed on the industrial asset;
(c) generating, by the mission planning engine, and based on the one or more separate asset datasets, for each task contained in the task dataset, a mission plan comprising one or more logically ordered actions to be performed by one or more agents of the industrial asset to complete the task; and
(d) providing, by the mission facilitation system, the mission plan to one of the one or more agents of the industrial asset.

2. The method of claim 1, wherein the one or more asset datasets comprises at least one of equipment sensor data, robot sensor data, and asset representation data.

3. The method of claim 1, further comprising:
(e) receiving, by the mission planning engine, one or more separate contextual datasets from the digital replica, wherein each of the one or more contextual datasets is at least one of pertains to the industrial asset and an environment in which the industrial asset is located.

4. The method of claim 3, wherein the one or more contextual datasets comprises an asset analytics dataset configured to forecast a future condition of the asset using the one or more separate asset datasets.

5. The method of claim 3, wherein the one or more contextual datasets comprises a climate dataset configured to forecast future local climatic conditions of the environment.

6. The method of claim 3, further comprising:
(f) aggregating, by the mission planning engine, the one or more asset datasets with the one or more contextual datasets to provide an aggregated dataset;
wherein (c) comprises generating, by the mission planning engine, and based on the aggregated dataset, for each task contained in the task dataset, the mission plan comprising the one or more logically ordered actions to be performed by the one or more agents of the industrial asset to complete the task.

7. The method of claim 1, further comprising:
(e) receiving, by the mission planning engine, a teleoperation dataset indicative of an availability of one or more teleoperated robots of the industrial asset.

8. The method of claim 7, wherein (d) comprises:
(d1) providing, by the mission facilitation system, teleoperation instructions to the one or more teleoperated robots, wherein the one or more agents comprise the one or more teleoperated robots and the mission plan comprises the teleoperation instructions.

9. The method of claim 1, wherein (d) comprises:
(d1) assigning, by the mission planning engine, specific tasks of the one or more logically ordered actions to specific agents of the one or more agents.

10. The method of claim 1, further comprising:
(e) assigning, by a mission optimization engine of the mission facilitation system, and based on the task dataset a priority to each of the one or more logically ordered actions; and
(f) optimizing, by the mission optimization engine, the mission plan to provide an optimized mission plan comprising an optimized one or more logically ordered actions;
wherein (d) comprises providing by the mission facilitation system the optimized mission plan to the one of the one or more agents of the industrial asset.

11. The method of claim 10, wherein:
(d) comprises assigning, by the mission planning engine, specific tasks of the one or more logically ordered actions to specific agents of the one or more agents; and
(e) comprises reassigning, by the mission optimization engine, at least some of the specific tasks of the one or more logically ordered actions to the specific agents of the one or more agents.

12. The method of claim 10, wherein (e) comprises assigning, by the mission optimization engine, the priority to each of the one or more logically ordered actions based on at least one of timeliness data and risk data contained in the task dataset.

13. A computer-readable medium storing executable code which, when executed by a processor, causes the processor to:
(a) receive, by a mission planning engine, of a mission facilitation system one or more separate asset datasets from a digital replica of an industrial asset, each of the one or more asset datasets pertaining to the industrial asset;
(b) receive, by the mission planning engine, a task dataset from a mission management platform defining a list of tasks to be performed on the industrial asset;
(c) generate, by the mission planning engine, and based on the one or more separate asset datasets, for each task contained in the task dataset, a mission plan comprising one or more logically ordered actions to be performed by one or more agents of the industrial asset to complete the task; and
(d) provide, by the mission facilitation system, the mission plan to one of the one or more agents of the industrial asset.

14. The computer-readable medium of claim 13, wherein the executable code, when executed by the processor, causes the processor to:
(e) assign, by a mission optimization engine of the mission facilitation system, and based on the task dataset a priority to each of the one or more logically ordered actions; and
(f) optimize, by the mission optimization engine, the mission plan to provide an optimized mission plan comprising an optimized one or more logically ordered actions;
wherein (d) comprises providing, by the mission facilitation system, the optimized mission plan to the one of the one or more agents of the industrial asset.

15. A computer-implemented method for facilitating one or more missions using a digital replica of an industrial asset, the method comprising:
(a) receiving, by a mission planning engine of a mission facilitation system, one or more separate asset datasets from the digital replica, each of the one or more asset datasets pertaining to the industrial asset;
(b) receiving, by the mission planning engine, a task dataset defining a list of tasks to be performed on the industrial asset;
(c) generating, by the mission planning engine, and based on the one or more separate asset datasets, for each task contained in the task dataset, a mission plan assigning a selected task to one or more agents of the industrial asset;
(d) performing, by a mission optimization engine of the mission facilitation system, a risk assessment for each of the mission plans to generate one or more corresponding optimized mission plans whereby at least some of the one or more agents are reassigned from a first task to a different task of the list of tasks; and
(e) providing, by the mission facilitation system, the one or more optimized mission plans to the one or more agents assigned to the one or more optimized mission plans.

16. The method of claim 15, wherein the one or more asset datasets comprises at least one of equipment sensor data, robot sensor data, and asset representation data.

17. The method of claim 15, further comprising:
(f) receiving, by the mission planning engine, one or more separate contextual datasets from the digital replica, wherein each of the one or more contextual datasets is at least one of pertains to the industrial asset and an environment in which the industrial asset is located.

18. The method of claim 17, wherein the one or more contextual datasets comprises an asset analytics dataset configured to forecast a future condition of the asset using the one or more separate asset datasets.

19. The method of claim 17, wherein the one or more contextual datasets comprises a climate dataset configured to forecast future local climatic conditions of the environment.

20. The method of claim 17, further comprising:
(f) aggregating, by the mission planning engine, the one or more asset datasets with the one or more contextual datasets to provide an aggregated dataset;
wherein (c) comprises generating, by the mission planning engine, and based on the aggregated dataset, for each task contained in the task dataset, the mission plan comprising one or more logically ordered actions to be performed by the one or more agents of the industrial asset to complete the task.
